(19) United States
(12) Patent Application Publication
(10) Pub. No.: US 2026/0176209 A1
(43) Pub. Date: Jun. 25, 2026

(54) COMPOSITION FOR DIRECTLY PRODUCING A CERAMIC MATRIX COMPOSITE MATERIAL

(71) Applicants: SAFRAN CERAMICS, LE HAILLAN (FR); CAPNOVIA, LOUARGAT (FR); INSTITUT REGIONAL DES MATERIAUX AVANCES, PLOEMEUR (FR); UNIVERSITE DE BRETAGNE SUD, LORIENT (FR)

(72) Inventors: Arnaud DELEHOUZE, MOISSY-CRAMAYEL (FR); Erwan LENEVEU, PLOEMEUR (FR); Yves-Marie CORRE, LORIENT (FR); Yves GROHENS, LORIENT (FR); Jacques PELLETER, LOUARGAT (FR)

(21) Appl. No.: 18/725,436

(22) PCT Filed: Dec. 23, 2022
(86) PCT No.: PCT/FR2022/052502

§ 371 Date: Jun. 28, 2024

(30) Foreign Application Priority Data
Dec. 28, 2021 (FR) 2114576

(51) Int. Cl. C04B 35/80; C04B 35/515; C04B 35/638; C04B 35/64

(52) U.S. Cl. CPC C04B 35/80; C04B 35/515; C04B 35/638; C04B 35/64; C04B 2235/3225; C04B 2235/3826; C04B 2235/96

(57) ABSTRACT

A composition for directly producing a ceramic matrix composite material includes a polymer phase including an thermoplastic elastomer and a low-density polyethylene, the content by volume of the polymer phase being between 40% and 65% relative to the total volume of the composition; fillers dispersed throughout the polymer phase, the content by volume of the fillers being between 35% and 65% relative to the total volume of the composition and including first fillers composed of particles selected from among particles of silicon carbide (SiC), boron carbide, silicon nitride, zirconia and alumina (Al₂O₃) or from among mixtures of the compounds; and second fillers composed of discontinuous fibrous reinforcements and/or particles that are larger in size than the first fillers, the content by volume of the second fillers being between 0% and 50% relative to the total volume of fillers in the composition.

### TECHNICAL FIELD

The invention relates to the field of direct production, and more precisely of raw materials suitable for the direct production of ceramic matrix composite material parts.

### PRIOR ART

Direct production is a method of increasing technological interest, in particular for the production of parts with complex geometries.

Conventionally, direct production methods for parts made of composite materials comprise depositing or printing a raw material using a printing head, for example guided by computer, according to a geometry in three dimensions corresponding to that of the part to be produced.

The solidification of the raw material is carried out after each layer deposited, so that a three-dimensional object is obtained after the printing step. This step corresponds to the production of a so-called “green body”.

In order to arrive at the final part, it is necessary to carry out, on the green body, a step of removing the organic material, called a debinding step, enabling a so-called “brown body” to be obtained. After this step, a sintering step is generally carried out in order to obtain a densified final part. Other shaping or finishing steps are optionally possible between the debinding and sintering steps, or after the sintering step.

The production of ceramic matrix composite materials by direct production is currently limited by the available raw materials for their production and by the technical constraints linked to the applicability of these raw materials for existing direct production methods.

The invention aims precisely to provide a raw material that can be used by known direct production methods and which enables ceramic matrix composite materials to be obtained.

### DISCLOSURE OF THE INVENTION

For this purpose, the inventors propose a composition for the direct production of a ceramic matrix composite material comprising:
a polymer phase comprising at least one thermoplastic elastomer and a low-density polyethylene, the content by volume of the polymer phase being between 20% and 80% relative to the total volume of the composition;
fillers dispersed in the polymer phase, the content by volume of the fillers being between 20% and 80% relative to the total volume of the composition and comprising:
first fillers composed of inorganic particles; and
second fillers composed of discontinuous fibrous reinforcements and/or particles that are larger in size than the first fillers, the content by volume of the second fillers being between 0% and 50% relative to the total volume of fillers in the composition.

These compositions can be used with the direct production methods, in particular by melting techniques such as extrusion, or fused filament fabrication (FFF) or by any other method applicable to thermoplastic raw materials.

Consequently, the compositions described make it possible to obtain ceramic matrix composite material parts, in particular with discontinuous reinforcement, with complex shapes, for example hollow shapes or shapes which require support, by already existing printing methods, without having to re-adapt the printing heads of these methods. In other words, the compositions are usable directly as raw material for the direct production of composite materials, in particular ceramic matrix composite materials.

In an embodiment, the content by volume of second filler can be 0%.

In this embodiment, the composition of the invention enables ceramic materials to be formed by the above-mentioned direct production methods.

In an embodiment, the content by volume of second filler can be strictly positive, for example between 0.1% and 50%, preferably between 5 and 50%, or even between 5 and 25% relative to the total volume of fillers of the composition.

In this embodiment, the composition of the invention enables the direct production of a ceramic matrix composite material with discontinuous reinforcement in an easier manner.

More specifically, the composition as described above is directly applicable to the already existing direct production methods, without the need to adapt these methods and in particular the step of forming the green body.

In an embodiment, the thermoplastic elastomers of the polymer phase can be chosen from thermoplastic polyurethane elastomers (TPU), thermoplastic styrene elastomers, thermoplastic copolyester elastomers, thermoplastic copolyamide elastomers (TPA), thermoplastic olefin elastomers, according to the classification from standard ISO 18064:2014. They are preferably chosen from thermoplastic styrene elastomers, thermoplastic copolyester elastomers and thermoplastic olefin elastomers.

In an embodiment, the polyethylenes of the polymer phase are chosen from low-density polyethylene (LDPE) and linear low-density the polyethylene (LLDPE). Their density generally ranges from 0.91 to 0.94 g/cm³ according to test standard ISO 1183-2:2019.

In an embodiment, the content by volume of polymer phase is between 40% and 80% relative to the total volume of the composition.

In an embodiment, the content by volume of polymer phase is between 40% and 65% relative to the total volume of the composition.

In an embodiment, the content by volume of polymer phase is between 45% and 60% relative to the total volume of the composition.

In direct production processes, the polymer phase is no longer present in the final part and is generally removed during a debinding step and the pores created by the removal of the polymer phase are filled by the sintering of the fillers.

It has been observed that the content by volume of polymer phase in the range proposed above, enables an optimum level of porosity to be created, in the sense that it is not too low and thus ensures that the sintering of the fillers fills all of the pores, nor is it too high, otherwise the density of the final part would be too low.

In an embodiment, the composition for the direct production of a ceramic matrix composite material comprises:
a polymer phase comprising at least one thermoplastic elastomer and a low-density polyethylene, the content by volume of the polymer phase being between 40% and 65% relative to the total volume of the composition;
fillers dispersed in the polymer phase, the content by volume of the fillers being between 20% and 80% relative to the total volume of the composition and comprising:
first fillers composed of particles chosen from particles of silicon carbide (SiC), boron carbide (B₄C), silicon nitride (Si₃N₄), zirconia (ZrO₂) and alumina (Al₂O₃), or from the mixtures of these compounds; and
second fillers composed of discontinuous fibrous reinforcements and/or particles that are larger than the first fillers, the content by volume of the second fillers being between 0% and 50% relative to the total volume of fillers in the composition,
   wherein the content by volume of first filler is between 25% and 40% relative to the total volume of the composition,
   and wherein the content by volume of second fillers is between 5% and 20% relative to the total volume of the composition.

In an embodiment, the polymer phase can further comprise a polyethylene glycol and/or a polyethylene terephthalate.

In an embodiment, the polymer phase of the composition can comprise:
between 50% and 98.75% by mass of a thermoplastic elastomer relative to the total mass of the polymer phase;
between 1.25% and 25% by mass of a low-density polyethylene relative to the total mass of the polymer phase;
between 0% and 25% by mass of a polyethylene glycol of molar mass ranging from 5000 to 20,000 g/mol relative to the total mass of the polymer phase;
between 0% and 15% by mass of polyethylene terephthalate relative to the total mass of the polymer phase.

It has been observed that such a polymer phase is suitable for the proposed direct production processes, and enables, in particular, good winding of the composition once this is in the form of filaments. Moreover, this composition has a homogeneous viscosity ensuring good compatibility with conventional printing heads. In addition, the composition enables a more significant inter-layer connection than with the processes of the prior art. It also has good debinding behaviour, by reducing the formation of cracks due to the removal of the organic compounds of the compositions of the prior art.

In an embodiment, the content by volume of fillers is between 20% and 60%, preferably between 35% and 60%, or even between 40% and 55% relative to the total volume of the composition.

In particular, in an embodiment where the fillers only compromise first fillers, the content by volume of filler is between 45% and 55% relative to the total volume of the composition.

In an embodiment, the composition comprises no elements other than the polymer phase and the fillers dispersed therein.

In an embodiment, the first fillers are particles with monomodal distribution, the median size d50 of which is between 1 μm and 15 μm.

The term “monomodal distribution” shall mean that the sizes of the set of the first filler particles are distributed around a single average size.

For example, the particle size distribution around the average size can be Gaussian.

By the definition of a median size d50, it is expected that as many particles of the distribution have a size less than the average as have a greater size.

It is observed that a distribution such as described above enables simplified sintering to be obtained, in particular since the size of the fillers is small. Through these dimensions for the first fillers, it is possible to obtain a very high level of densification in the final part obtained after sintering, in particular greater than 95%.

In another embodiment, the particle size distribution of the first fillers can be multimodal.

The choice of a multimodal particle size distribution makes it possible to modify the rheology of the composition, and can increase the filler content by volume of first fillers. The increase in the content by volume of first fillers in the composition makes it possible to obtain a part for which the final densification is simplified.

In an embodiment, the first fillers are chosen from particles of silicon carbide (SIC), boron carbide (B₄C), silicon nitride (Si₃N₄), zirconia (ZrO₂) and alumina (Al₂O₃) or from the mixtures of these compounds.

In an embodiment in which the fillers comprise first and second fillers, the content by volume of first fillers is between 25% and 50% relative to the total volume of the composition, for example between 25% and 40%.

The first filler particles can create the ceramic matrix in the final part.

In an embodiment, the content by volume of second fillers is between 5% and 35% relative to the total volume of the composition, for example between 5% and 25%, or even between 5 and 20%.

In an embodiment, the content of second filler can be preferably between 11% and 42% relative to the volume of fillers of the composition.

In an embodiment, the second fillers are discontinuous fibrous reinforcements, for example discontinuous fibres and/or particles of larger size than the first fillers.

The differentiation between particles and fibres can be made via the determination of the shape factor of the second fillers.

Here, the shape factor for an object is understood as the ratio between the longest dimension and shortest dimension. Thus, a perfectly spherical particle has a shape factor of 1. It can be said that an object is particle shaped if its shape factor is between 1 and 3, whereas it is considered that an object is fibrous when its shape factor is greater than 3.

For example, the second fillers can be short fibres having a shape factor between 3 and 625, preferably between 10 and 65.

In an embodiment, the second fillers are chosen from carbon fibres, silicon carbide fibres, oxide fibres, glass fibres and/or silicon carbides particles.

In another embodiment, the second fillers are particles of SiC, for which the average size value d50 is between 50 μm and 500 μm, for example between 150 μm and 250 μm.

In an embodiment, the second fillers are short fibres which can have an average length between 50 μm and 5000 μm, preferably between 150 μm and 500 μm, or even between 150 μm and 250 μm.

In an embodiment, the short fibres can have a diameter between 8 μm and 14 μm. The inventors have observed that fibres of the sizes indicated above make it possible, on the one hand, to have fibres that are sufficiently long to obtain an improvement in the mechanical properties of the final part, and, on the other hand, to have fibres sufficiently short to maintain easy use in direct production processes. In particular, it is observed that the sizes indicated above are compatible with printing heads for existing direct production methods, in particular those of fused filament deposition methods.

In an embodiment, there are no fillers in the composition other than the first and, where appropriate, the second fillers.

In an embodiment, the second fillers can be coated with an interphase and/or a protective deposit.

Such a deposit can reduce the fragility of the composite material. The protection of the second fillers by the interphase can reduce the vulnerability of these fillers to oxidation or to thermochemical attack which may be encountered during the later treatment. In addition, the interphase and/or the protective deposition can enable better wetting of the matrix during the sintering step. In an embodiment, the surface of the second fillers can be functionalised, for example in order to improve the wettability of the organic compounds and/or to increase the chemical compatibility between the fillers and the organic compounds.

In another of its aspects, the invention also relates to a direct production process for a ceramic matrix composite material part with discontinuous reinforcement comprising the following steps:
depositing a composition as described above;
a step of removing the organic phase;
a step of densification of the part obtained.

In an embodiment, the step of removing the organic phase can be carried out by heating, for example to a temperature greater than 1000° C., or else less than 600° C.

In an embodiment, this step can be carried out under vacuum or under a special atmosphere, in particular an inert atmosphere, for example under argon.

In an embodiment, the densification step can be chosen from sintering, carried out without stress, sintering with stress, a spark plasma sintering method (SPS), or else densification by capillary rise of a molten metal.

In a preferred embodiment, the densification step can be a sintering step carried out under stress.

The inventors have observed that this embodiment makes it possible to obtain a final part, from a composition as described above, the density of which final part is particularly high, in particular greater than 95%.

### DESCRIPTION OF THE EMBODIMENTS

The invention is now described by means of particular exemplary embodiments which should not be interpreted as limiting the invention.

As described above, a composition according to the invention comprises fillers dispersed in a polymer phase.

In an embodiment, a composition of the invention can be prepared by incorporating, in a first step, first fillers in a polymer phase, then in a second step adding the second fillers to this assembly.

In the case where the second fillers are discontinuous fibrous reinforcements, these can be produced on the one hand and introduced directly in this form into a mixture of a polymer phase and first fillers.

This embodiment is particularly preferred when the second fillers are coated with a protective coating and/or an interphase.

In an alternative embodiment, the composition can be obtained from a mixture of first fillers and long fibres dispersed in a polymer phase, the long fibres then being ground by mechanical shearing action in order to directly form the second fillers in the composition.

For example, this embodiment can be implemented in a co-rotating twin screw mixer.

In this embodiment, the discontinuous fibres can be added to the polymer phase containing the first fillers in a mixer, at a specific location in the mixer by side feeding.

The embodiments in which the composition is obtained in a mixer can ensure a homogeneous distribution of first and second fillers within the composition, which ensures the ultimate obtaining of a ceramic material part with homogeneous properties.

In an embodiment, the composition is mixed several times before being used in a direct production process. In other words, a composition according to the invention can be introduced into a mixer, for example a twin-screw mixer, before being used in a direct production process.

In an embodiment, the composition can be shaped to constitute a raw material that can be used in a direct production process.

For example, in the case where a fused filament deposition process is chosen, the composition can be shaped by extrusion spinning using a single-screw extruder.

Fused filament deposition methods are particularly preferred.

In an embodiment where the direct production process is an extrusion process, the composition can be granulated in particles, the dimensions of which are of order 1 to 5 mm and have cylindrical or spherical shape.

In an embodiment where the direct production process is a fused filament deposition process, the composition can be in the form of a continuous filament, for example of a calibrated diameter, for example less than 3 mm.

The debinding step of the green body is carried out by heating, by introducing a solvent or by a combination of these two methods. The aim of this step is to cause a removal of the organic material and thus to guarantee good densification of the part.

As described above, this step can be carried out under air or under a particular atmosphere.

This choice is made according to the nature of the filler. For example, when the filler is a ceramic oxide, a treatment under air may be suitable. When the filler is a carbide, it is preferable to use an inert atmosphere, for example argon.

The debinding step can be carried out at a pressure less than or equal to atmospheric pressure.

In another embodiment, the debinding step can be carried out under supercritical conditions, for example with supercritical CO₂.

After the debinding step, a densification step is carried out on the brown body in order to obtain the final part. This densification step enables the fillers to occupy the pores left vacant by the removal of the organic materials and thus to increase the density of the final part.

The choice of process applied for the densification depends on the nature of the first and second fillers. More specifically, the sintering capacity of the debound part is not only a function of the nature of the first or second fillers, but also of the interactions between them.

In particular, it is observed that when the second fillers are fibrous reinforcements, the rise in temperature alone does not simply make it possible to achieve sintering of the part. It may be necessary to carry out a sintering under stress, in other words by applying a pressure on the part.

It has been shown that the composition according to the invention makes it possible to obtain a ceramic matrix composite material part with discontinuous reinforcements via a direct production process applicable with a thermoplastic raw material. In this way, the ceramic matrix composite material part with discontinuous reinforcements is obtained in a simplified manner and/or makes it possible to access more complex geometries of parts than those which are accessible by other currently known direct production processes for obtaining parts composed of these materials.

In the present application the expression “between . . . and . . . ” should be understood to include the limits.

### EXAMPLE

Compositions according to the invention have been prepared, and their applicability to additive manufacturing techniques has been tested.

The compositions of table 1 illustrate compositions that are satisfactory for the preparation of filaments for fused filament deposition processes. The compositions of table 1 are given as content by volume for the components of the fillers dispersed in the polymer phase relative to the total volume of the composition. Thus, for each composition, the content by volume of the polymer phase is the complement to 100 of the volume contents given for the first, and where appropriate second, fillers. In each example, the polymer phase comprises a thermoplastic elastomer, for example a polyester elastomer and a low-density polyethylene. The sign “--” in table 1 indicates that the second fillers are not present.

TABLE 1

| | |
|---|---|
| First filler (particles) | Second filler (short fibres) |

| | Content by | | Content by |
|---|---|---|---|
| Nature | volume (%) | Nature | Volume (%) |
| Alumina | 54 | — | — |
| Alumina | 48 | — | — |
| Zirconia | 55 | — | — |
| Zirconia | 48 | — | — |
| SiC | 53 | — | — |
| SiC | 48 | — | — |
| SiC | 48 | C | 5 |
| SiC | 42 | C | 5 |
| SiC | 39 | C | 14 |
| SiC | 34 | C | 14 |
| SiC (80%) | 33 | C | 20 |
| B₄C (20%) | | | |
| SiC (80%) | 28 | C | 20 |
| B₄C (20% | | | |
| Alumina | 45 | glass | 5 |
| Alumina | 35 | glass | 5 |
| Alumina | 30 | alumina | 10 |

1. A composition for direct production of a ceramic matrix composite material comprising:
a polymer phase comprising at least one thermoplastic elastomer and a low-density polyethylene, the content by volume of the polymer phase being between 40% and 65% relative to the total volume of the composition;
fillers dispersed in the polymer phase, the content by volume of the fillers being between 35% and 60% relative to the total volume of the composition and comprising:
first fillers composed of particles chosen from particles of silicon carbide (SiC), boron carbide (B₄C), silicon nitride (Si₃N₄), zirconia (ZrO₂) and alumina (Al₂O₃), or from the mixtures of these compounds; and
second fillers composed of discontinuous fibrous reinforcements that are larger than the first fillers, the content by volume of the second fillers being between 0% and 50% relative to the total volume of fillers in the composition,
wherein the content by volume of first filler is between 25% and 40% relative to the total volume of the composition,
wherein the content by volume of second fillers is between 5% and 20% relative to the total volume of the composition,
and wherein the second fillers are fibres having a length between 150 μm and 250 μm.

2. The composition according to claim 1, wherein the polymer phase comprises:
between 50% and 98.75% by mass of a thermoplastic elastomer relative to the total mass of the polymer phase;
between 1.25% and 25% by mass of a low-density polyethylene relative to the total mass of the polymer phase;
between 0% and 25% by mass of a polyethylene glycol of molar mass ranging from 5,000 to 20,000 g/mol relative to the total mass of the polymer phase;
between 0% and 15% by mass of polyethylene terephthalate relative to the total mass of the polymer phase.

3. The composition according to claim 1, wherein the first fillers are particles with monomodal distribution, for which the median size d50 is between 1 and 15 μm.

4. The composition according to claim 1, wherein the second fillers are chosen from carbon fibres, silicon carbide fibres, oxide fibres, glass fibres and/or particles of silicon carbide.

5. (canceled)

6. A method for direct production of a part made of ceramic matrix composite material with discontinuous reinforcement comprising the following steps:
depositing a composition according to claim 1;
a step of removing the organic phase;
a step of densification of the part obtained.

7. The direct production method according to claim 6, wherein the densification step is a sintering step carried out under stress.
